(19) United States
(12) Patent Application Publication
(10) Pub. No.: US 2026/0302826 A1
(43) Pub. Date: Oct. 1, 2026

(54) UNINTERRUPTIBLE POWER SUPPLY SYSTEM AND CONTROL METHOD THEREOF

(71) Applicant: SANTAK ELECTRONIC (SHENZHEN) CO., LTD., SHENZHEN (CN)

(72) Inventors: Zengwu CHEN, Shenzhen (CN); Zhe WANG, Shenzhen (CN); Jingjin YU, Shenzhen (CN)

(21) Appl. No.: 19/576,007

(22) Filed: Mar. 24, 2026

(30) Foreign Application Priority Data
Mar. 26, 2025 (CN) 202510364326.0

(51) Int. Cl. H02J 9/06

(52) U.S. Cl. CPC H02J 9/06

(57) ABSTRACT

An uninterruptible power system includes an input terminal, an output terminal, at least one uninterruptible power module, a second controllable switch, and a system controller having a bus port and a first output port. Each uninterruptible power module includes a module control unit and a discrete bypass from the input to the output terminal, each discrete bypass having a first controllable switch configured to control an on- and off-state of the respective discrete bypass, and each module control unit including a module controller and a signal processor. The system controller is configured to send a first instruction to the module controller, the first instruction being configured to instruct the module controller to send a first control signal, and a second instruction to the second controllable switch through the first output port, the second instruction being configured to instruct the second controllable switch to send a second control signal.

### CROSS REFERENCE TO RELATED APPLICATIONS

This application claims benefit to Chinese Patent Application No. 202510364326.0, filed on Mar. 26, 2025, which is hereby incorporated by reference herein.

### FIELD

The present disclosure relates to the field of power supplies, and in particular, to an uninterruptible power system and a control method thereof.

### BACKGROUND

The statements in this part are merely intended to provide background information related to the present disclosure, to help understand the present disclosure. The background information does not necessarily constitute the prior art.

In a modern power supply system, an uninterruptible power system (UPS) is a critical power protection device, which is widely used in the fields of computers, communication network systems, industrial control systems, industrial devices that require continuous operation, and the like. A core function of the UPS is to provide stable and uninterrupted power for key devices, ensuring normal operation of the devices during mains supply outages or abnormalities, and preventing data loss or device damage caused by power-related issues. To improve system flexibility and scalability, a modern uninterruptible power system typically uses a modular design, including one or more parallel uninterruptible power modules (UPM). This modular design not only facilitates maintenance and upgrade, but also implements flexible adjustments of the power output of the system according to user requirements.

In practical applications, users often need to perform bypass control on the UPM according to different operating conditions. For example, when mains supply parameters are normal, the user hopes that the uninterruptible power system can be switched to operate in a bypass mode to improve system efficiency and reduce energy consumption. The bypass mode allows the UPS to directly supply power to a load through the mains supply, thus reducing losses during energy conversion.

### SUMMARY

In an embodiment, the present disclosure provides an uninterruptible power system, comprising an input terminal, an output terminal, at least one uninterruptible power module, a second controllable switch, and a system controller having a bus port and a first output port. Each uninterruptible power module comprises a module control unit and a discrete bypass from the input terminal to the output terminal, each respective discrete bypass having a first controllable switch configured to control an on and off state of the respective discrete bypass, and each module control unit comprising a module controller and a signal processor. The system controller is configured to send a first instruction to the module controller of the at least one uninterruptible power module through the bus port, the first instruction being configured to instruct the module controller to send a first control signal. The system controller is further configured to send a second instruction to the second controllable switch through the first output port, the second instruction being configured to instruct the second controllable switch to send a second control signal. The signal processor is configured to output an enable signal under control of the first control signal or the second control signal, the enable signal being configured to control a closing and opening of the first controllable switch.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of a circuit of an uninterruptible power system according to an embodiment of the present disclosure;

FIG. 2 shows a schematic diagram of a circuit of an uninterruptible power system according to an embodiment of the present disclosure;

FIG. 3 shows a schematic diagram of a circuit of an uninterruptible power system according to an embodiment of the present disclosure;

FIG. 4 shows an embodiment of a sub-switch shown in FIG. 2;

FIG. 5 shows a schematic diagram of a circuit of a signal processing unit according to an embodiment of the present disclosure; and

FIG. 6 shows a schematic diagram of a circuit of a flyback power supply according to an embodiment of the present disclosure.

### DETAILED DESCRIPTION

In an embodiment, the present disclosure overcomes the foregoing disadvantages in the prior art, and provides an uninterruptible power system and a control method thereof.

According to an aspect of embodiments of the present application, an uninterruptible power system is provided, including:
an input terminal and an output terminal;
at least one uninterruptible power module, each uninterruptible power module in the at least one uninterruptible power module including a module control unit and a discrete bypass from the input terminal to the output terminal, the discrete bypass having a first controllable switch configured to control on and off of the discrete bypass, and the module control unit including a module controller and a signal processing unit;
a second controllable switch; and
a system control unit, having a bus port and a first output port,
where the system control unit is configured to:
send a first instruction to the module controller of the at least one uninterruptible power module through the bus port, the first instruction instructing the module controller to send a first control signal; and
send a second instruction to the second controllable switch through the first output port, the second instruction instructing the second controllable switch to send a second control signal; and
the signal processing unit is configured to output an enable signal under the control of the first control signal or the second control signal, the enable signal being configured to control close and open of the first controllable switch.

In an embodiment of the uninterruptible power system according to the present disclosure, the system control unit and the module controller each include a digital signal processor.

In an embodiment of the uninterruptible power system according to the present disclosure, the first controllable switch includes two SCRs connected in reverse parallel.

In an embodiment of the uninterruptible power system according to the present disclosure, the second controllable switch includes a plurality of sub-switches that are in a one-to-one correspondence with respective uninterruptible power modules in the at least one uninterruptible power module, the plurality of sub-switches each are a transistor, a base of the transistor is configured to receive the second instruction, a collector of the transistor is configured to send the second control signal to the signal processing unit of the uninterruptible power module corresponding to the transistor, and a transmitter of the transistor is coupled to a ground terminal.

In an embodiment of the uninterruptible power system according to the present disclosure, the signal processing unit includes a first inverter, a second inverter, a PWM control chip, and an isolated switching power supply module, an input terminal of the first inverter is configured to receive the first control signal, an output terminal of the first inverter is coupled to an input terminal of the second inverter, the input terminal of the second inverter is configured to receive the second control signal, an output terminal of the second inverter is coupled to an input terminal of the PWM control chip, an output terminal of the PWM control chip is coupled to an input terminal of the isolated switching power supply module, and the isolated switching power supply module is controlled by a pulse width modulation signal output by the PWM control chip to output the enable signal.

In an embodiment of the uninterruptible power system according to the present disclosure, the isolated switching power supply module is a flyback power supply or a forward power supply.

In an embodiment of the uninterruptible power system according to the present disclosure, the module controller is further configured to send a status signal to the system control unit through the bus port, and the system control unit determines, based on the status signal, whether the module controller is faulty.

In an embodiment of the uninterruptible power system according to the present disclosure, each uninterruptible power module in the at least one uninterruptible power module further includes an auxiliary power supply module, and the auxiliary power supply module is configured to:
supply power to a module control unit of an uninterruptible power module in which the auxiliary power supply module is located; and
serve as a backup power supply of a module control unit of another uninterruptible power module in the at least one uninterruptible power module.

According to an embodiment of the present disclosure, a control method for the uninterruptible power system according to the present disclosure is further provided, including:
controlling the system control unit to simultaneously send a first instruction and a second instruction, where the module controller sends a first control signal based on the received first instruction, the second controllable switch sends a second control signal based on the received second instruction, the signal processing unit outputs an enable signal based on one of the first control signal or the second control signal that arrives first, and the enable signal controls the uninterruptible power system to switch to a bypass mode.

In an embodiment of the control method according to the present disclosure further includes:
when the uninterruptible power system is in the bypass mode and an uninterruptible power module in the at least one uninterruptible power module is faulty, controlling the system control unit to determine, based on a status signal sent by the module control unit that controls the uninterruptible power module, whether the module controller of the module control unit is faulty;
where when the module controller is not faulty, the system control unit is controlled to send a first instruction through the bus port, the module controller sends a first control signal based on the received first instruction, the signal processing unit outputs an enable signal based on the first control signal, and the enable signal controls the uninterruptible power system to remain in the bypass mode; and
where when the module controller is faulty, the system control unit is controlled to send a second instruction through the first output port, the second controllable switch sends a second control signal based on the received second instruction, the signal processing unit outputs an enable signal based on the second control signal, and the enable signal controls the uninterruptible power system to remain in the bypass mode.

In an embodiment of the present disclosure, the system control unit of the UPS and the module control units of the UPMs of the UPS are optimized, thereby implementing the bypass control of the uninterruptible power system. Compared with the prior art, embodiments of the present disclosure do not need to use a single-chip microcomputer, thereby reducing costs and simplifying system control. In addition, embodiments of the present disclosure further implement a dual-signal fast start mechanism of the bypass mode of the UPS, so that a problem of affecting bypass mode switching due to a communication packet loss is effectively avoided, and a defect in the prior art that a single-chip microcomputer or a DSP in the UPM fails to maintain the bypass mode is overcome, thereby significantly improving reliability and availability of the system.

To make the objectives, technical solutions, and advantages of embodiments of the present disclosure clearer, the following further describes exemplary embodiments with reference to the accompanying drawings. It should be understood that the described embodiments are some but not all of the embodiments of the present disclosure. All other embodiments obtained by a person of ordinary skill in the art based on the embodiments of the present disclosure without creative efforts shall fall within the scope of the present disclosure.

In addition, the described features, structures, or characteristics can be incorporated in one or more embodiments in any suitable manner. In the following description, many specific details are provided to give a full understanding of the embodiments of the present disclosure. However, a person skilled in the art will recognize that the technical solutions of the present disclosure can be practiced without one or more of specific details, or other methods, components, apparatuses, steps, or the like can be used. In other cases, a well-known method, apparatus, implementation, or operation is not shown or described in detail to avoid blurring various aspects of the present disclosure.

An uninterruptible power system plays an important role in modern power supply and it ensures uninterruptible operation of key devices by providing a backup power supply and a voltage regulation function. Typically, an uninterruptible power system mainly includes a primary branch including an AC-DC conversion module (rectifier), a DC-AC conversion module (inverter), and the like, a battery branch including a battery, a DC-DC conversion module (charging module) for charging the battery, and a DC-DC conversion module (discharging module) for performing direct current conversion on an output voltage of the battery, and a discrete bypass from an input terminal to an output terminal of the uninterruptible power system. The bypass control of a UPS refers to controlling turn-on of the discrete bypass in case of a fault, energy saving, or the like to directly connect a load to the mains supply or another power supply, so as to supply power to the load bypassing the primary branch and the battery branch (that is, the UPS is switched to a bypass mode). In addition, when a power supply mode of the primary branch or the battery branch needs to be restored, the discrete bypass is controlled to be disconnected, so that the UPS exits the bypass mode.

The inventors have found, in accordance with the present disclosure, that in the traditional design of the uninterruptible power system, bypass control is a complex task, and usually needs to be implemented by the collaborative operation of a digital signal processor (DSP) of the UPS, a DSP of the UPM, and a single-chip microcomputer inside the UPM. Although this design can improve reliability of the system to some extent, it has some limitations. First, the single-chip microcomputer has high costs, which increases the overall costs of the system. Second, the design of a plurality of processors operating in coordination requires precise control logic and real-time monitoring, which increases control difficulty. More importantly, when the UPM is faulty and is in the bypass mode, the bypass mode of the UPM cannot be maintained once the single-chip microcomputer inside the UPM or the DSP of the UPM is faulty (e.g., due to a power loss, a fault of a DSP component, or a breakdown of DSP software). This may cause a bypass current of each UPM to increase due to a certain UPM fault, thereby triggering over-temperature protection, which further affects reliability and availability of the system.

In view of the foregoing challenges existing in the bypass control of the UPS, such as problems of relatively high control complexity and the like, the present disclosure provides an uninterruptible power system and a control method thereof.

The system control unit 106 has a bus port CAN1 and a first output port P1. The bus port CAN1 is coupled to an input terminal of the module controller 1043, the first output port P1 is coupled to an input terminal of the second controllable switch 105, an output terminal of the module controller 1043 and an output terminal of the second controllable switch 105 are respectively coupled to a first input terminal and a second input terminal of the signal processing unit 1042, and an output terminal of the signal processing unit 1042 is coupled to a controllable terminal of the first controllable switch 1031.

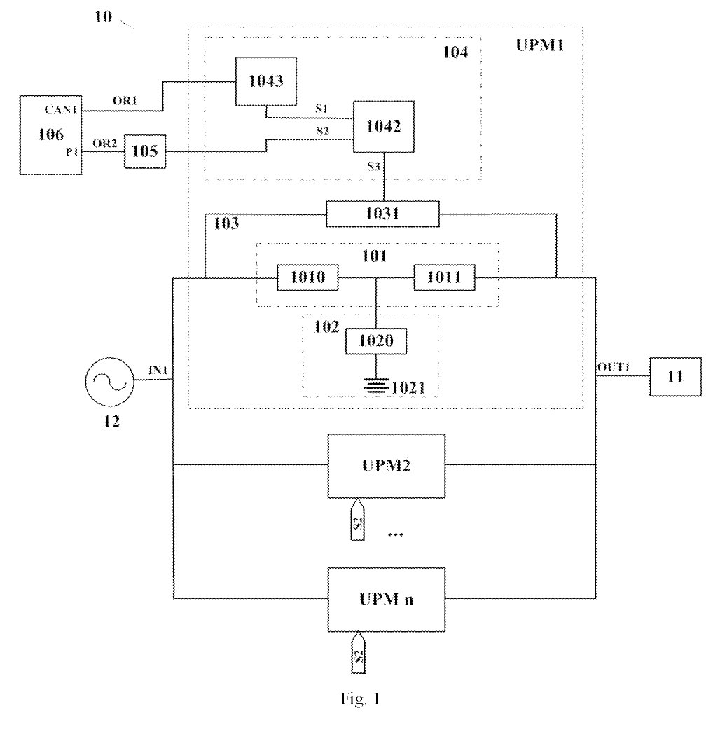

FIG. 1 shows a schematic diagram of a circuit of an uninterruptible power system according to an embodiment of the present disclosure. As shown in FIG. 1, a UPS 10 includes an input terminal IN1, an output terminal OUT1, n uninterruptible power modules UPM 1 to UPM n (for simplicity, the following descriptions refers to the UPM 1 unless otherwise stated, but a person skilled in the art understands that these descriptions are equally applicable to other UMPs), a second controllable switch 105, and a system control unit (also referred to herein as a system controller) 106. Wherein, the input terminal IN1 of the UPS 10 is configured to be coupled to an alternating current power supply 12, the output terminal OUT1 of the UPS 10 is configured to be coupled to a load 11, and the uninterruptible power modules UPM 1 to UPM n are connected in parallel between the input terminal IN1 and the output terminal OUT1. Each uninterruptible power module UPM1 in the uninterruptible power modules UPM 1 to UPM n includes a primary branch 101, a battery branch 102, a discrete bypass 103 from the input terminal IN1 to the output terminal OUT1, and a module control unit 104. Wherein, the discrete bypass 103 has a first controllable switch 1031 configured to control on and off of the discrete bypass 103, and the module control unit 104 includes a module controller 1043 and a signal processing unit (also referred to herein as a signal processor) 1042.

Wherein, the system control unit 106 is configured to: i) send a first instruction OR1 to the module controller 1043 of the uninterruptible power module UPM1 through the bus port CAN1, the first instruction OR1 instructing the module controller 1043 to send a first control signal S1; and ii) send a second instruction OR2 to the second controllable switch 105 through the first output port P1, the second instruction OR2 instructing the second controllable switch 105 to send a second control signal S2. The signal processing unit 1042 is configured to output an enable signal S3 under the control of the first control signal S1 or the second control signal S2, the enable signal S3 being configured to control close and open of the first controllable switch 1031. By means of this redundancy design, the two control signals S1 and S2 serve as backups for each other. Even if one signal fails, the other signal can ensure normal operation of the bypass mode, thereby effectively avoiding a system fault caused by a single-signal failure, and improving reliability and stability of the system.

In some embodiments of the present disclosure, the primary branch 101 includes a rectifier module 1010 and an inverter module 1011 that are sequentially connected between the input terminal IN1 and the output terminal OUT1, the battery branch 102 includes a charging/discharging module (also referred to as a power conversion module) 1020 and a battery 1021, and the battery branch 102 is configured to be coupled to a node between the rectifier module 1010 and the inverter module 1011.

In some embodiments of the present disclosure, the system control unit 106 and the module controller 1043 each include a digital signal processor (DSP).

In some embodiments of the present disclosure, the first controllable switch 1031 located in the discrete bypass 103 includes two semiconductor devices connected in reverse parallel, for example, a silicon controlled rectifier (SCR) or an insulated gate bipolar transistor (IGBT). Wherein, the SCR, as a common semiconductor device, has significant advantages of low price and simple control. Compared with other semiconductor devices, the SCR has lower manufacturing costs, can effectively reduce the overall costs of the system. Meanwhile, the control logic of the SCR is simple, and the SCR can be turned on and off simply by a triggering signal, thereby reducing complexity of the system design and debugging difficulty. In addition, the SCR also has high voltage withstand capability and high current bearing capability, so that the SCR is suitable for high power scenarios to ensure reliable operation in a bypass mode.

In some embodiments of the present disclosure, the module controller 1043 is further configured to send a status signal to the system control unit 106 through the bus port CAN1, and the system control unit 106 may determine, based on the status signal, whether the module controller 1043 is faulty.

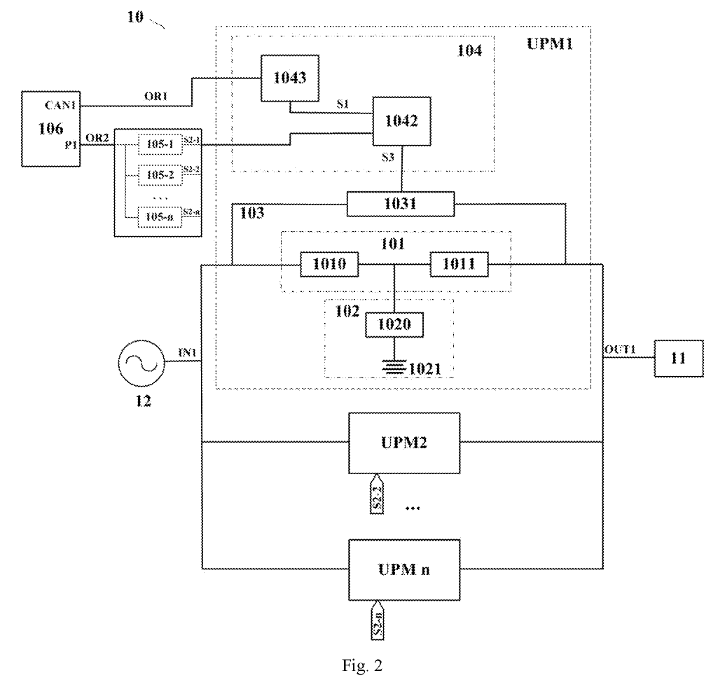

FIG. 2 shows a schematic diagram of a circuit of an uninterruptible power system according to another embodiment of the present disclosure. As shown in FIG. 2, in this embodiment, the second controllable switch 105 includes a plurality of sub-switches 105-1 to 105-n that are in a one-to-one correspondence with respective uninterruptible power modules in the uninterruptible power modules UPM 1 to UPM n. The sub-switch 105-1 receives the second instruction OR2 and sends a second control signal S2-1 to the signal processing unit of the UPM 1, the sub-switch 105-2 receives the second instruction OR2 and sends a second control signal S2-2 to the signal processing unit of the UPM 2, and so on. The signal processing unit 1042 of the UPM 1 is configured to output an enable signal S3 under the control of the first control signal S1 or the second control signal S2-1, the enable signal S3 being configured to control close and open of the first controllable switch 1031. The other UPMs are similarly configured. In this solution, the second controllable switch 105 is designed as a plurality of sub-switches 105-1 to 105-n that are in a one-to-one correspondence with respective UPMs, thereby significantly improving product integration. This integrated design not only reduces the number of external circuits and components, but also optimizes the system layout, thereby reducing the overall volume and manufacturing costs. Meanwhile, each sub-switch independently controls a corresponding UPM, ensuring high efficiency and flexibility of the system. Even when a UPM is faulty, the other UPMs can operate normally, thereby further improving reliability and stability of the system.

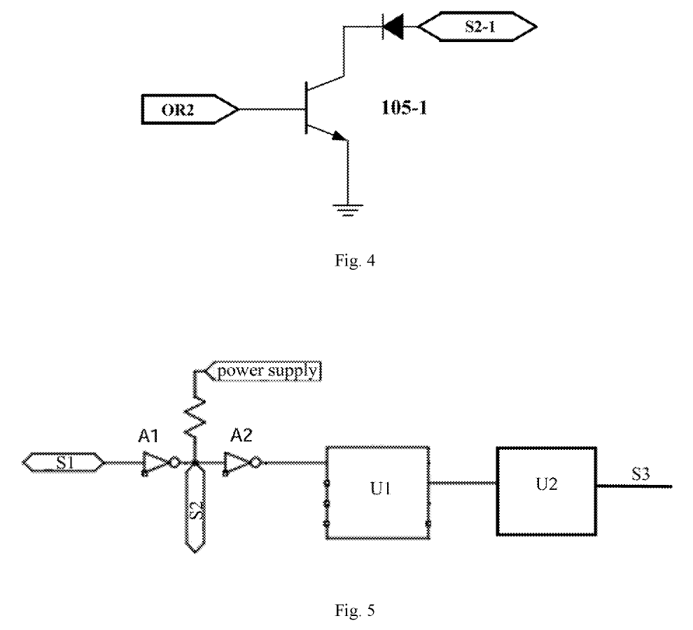

In some embodiments of the present disclosure, the second controllable switch 105 or the plurality of sub-switches 105-1 to 105-n are all transistors. As shown in FIG. 4, taking the transistor 105-1 as an example, a base of the transistor 105-1 is configured to receive a second instruction OR2, a collector of the transistor 105-1 is configured to send a second control signal S2-1 to the signal processing unit 1042 of the uninterruptible power module UPM 1 corresponding to the transistor 105-1, and an emitter of the transistor 105-1 is coupled to a ground terminal.

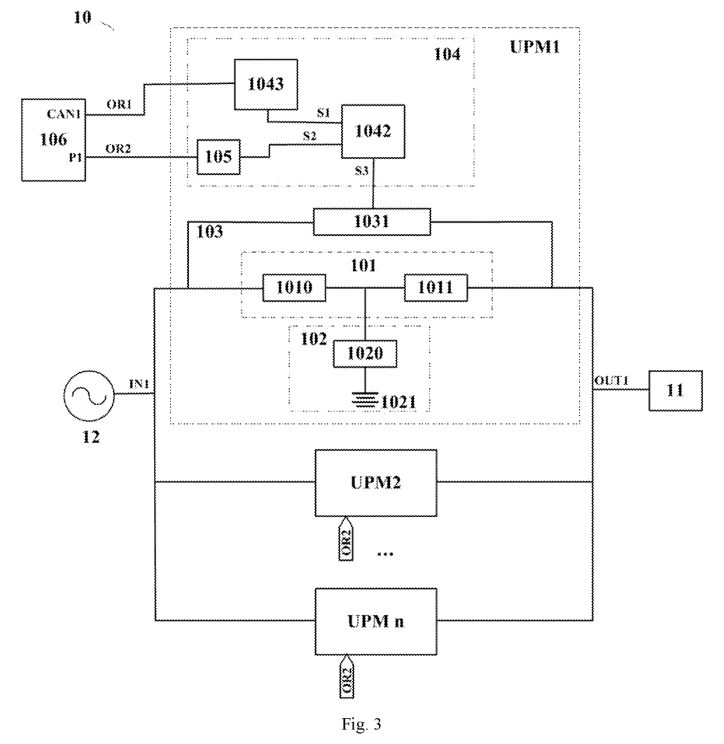

FIG. 3 shows a schematic diagram of a circuit of an uninterruptible power system according to another embodiment of the present disclosure. As shown in FIG. 3, the UPS 10 includes an input terminal IN1, an output terminal OUT1, uninterruptible power modules UPM 1 to UPM n, and a system control unit 106. The input terminal IN1 of the UPS 10 is configured to be coupled to an alternating current power supply 12, the output terminal OUT1 of the UPS 10 is configured to be coupled to a load 11, and the uninterruptible power modules UPM 1 to UPM n are connected in parallel between the input terminal IN1 and the output terminal OUT1. Each uninterruptible power module UPM1 in the uninterruptible power modules UPM 1 to UPM n includes a primary branch 101, a battery branch 102, a discrete bypass 103 from the input terminal IN1 to the output terminal OUT1, and a module control unit 104. Wherein, the discrete bypass 103 has a first controllable switch 1031 configured to control on and off of the discrete bypass 103, and the module control unit 104 includes a module controller 1043, a signal processing unit 1042, and a second controllable switch 105. Wherein, the system control unit 106 is configured to: send a first instruction OR1 to the module controller 1043 of the uninterruptible power module UPM1 through the bus port CAN1, the first instruction OR1 instructing the module controller 1043 to send a first control signal S1; and send a second instruction OR2 to the second controllable switch 105 through the first output port P1, the second instruction OR2 instructing the second controllable switch 105 to send a second control signal S2; and the signal processing unit 1042 is configured to output an enable signal S3 under the control of the first control signal S1 or the second control signal S2, the enable signal S3 being configured to control close and open of the first controllable switch 1031. Preferably, in this embodiment, the second controllable switch 105 is a transistor. The transistor has low costs and is easy to control. In this solution, the second controllable switch 105 is designed within each UPM, thereby significantly improving the product integration of the module control unit of the UPM. This integrated design not only reduces the number of external circuits and components, but also optimizes the system layout, thereby reducing the overall volume and manufacturing costs. Meanwhile, each sub-switch independently controls a corresponding UPM, ensuring high efficiency and flexibility of the system. Even when a UPM is faulty, the other UPMs can operate normally, thereby further improving reliability and stability of the system.

FIG. 5 shows a schematic diagram of a circuit of a signal processing unit according to an embodiment of the present disclosure. As shown in FIG. 5, in some embodiments of the present disclosure, the signal processing unit 1042 includes a first inverter A1, a second inverter A2, a PWM control chip U1, and an isolated switching power supply module U2. Wherein, an input terminal of the first inverter A1 is configured to receive the first control signal S1, an output terminal of the first inverter A1 is coupled to an input terminal of the second inverter A2, and the input terminal of the second inverter A2 is configured to receive the second control signal S2. An output terminal of the second inverter A2 is coupled to an input terminal of the PWM control chip, an output terminal of the PWM control chip is coupled to an input terminal of the isolated switching power supply module U2, and the isolated switching power supply module U2 is controlled by a pulse width modulation signal output by the PWM control chip to output the enable signal S3.

In some embodiments of the present disclosure, the UPS 10 controls the system control unit 106 to send the first instruction OR1 through the bus port CAN1, the module controller 1043 sends the first control signal S1 based on the received first instruction OR1, and the first control signal S1 may be a high-level signal. The first control signal S1 is input to the first inverter A1, and then output to the PWM control chip U1 through the second inverter A2. The signal output by the second inverter A2 is a high-level signal. The PWM control chip U1 outputs the pulse width modulation signal based on the received high-level signal, the isolated switching power supply module U2 outputs the enable signal S3 under the control of the pulse width modulation signal output by the PWM control chip, and the enable signal S3 is a pulse signal.

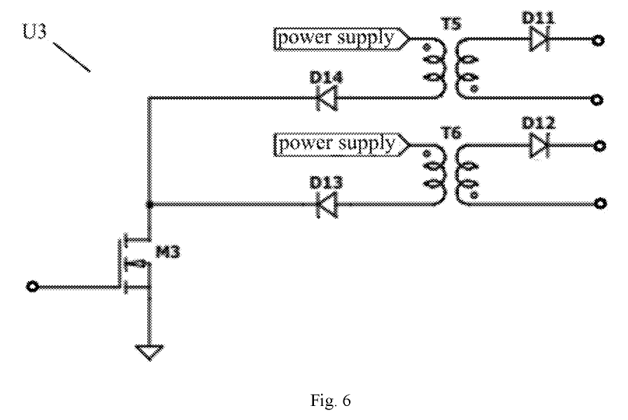

In some embodiments of the present disclosure, the UPS 10 controls the system control unit 106 to send the second instruction OR2 through the first output port P1, the second instruction OR2 may be a high-level signal, the second controllable switch 105 sends the second control signal S2 based on the received second instruction OR2, and the second control signal S2 is a low-level signal. The second control signal S2 is output to the PWM control chip U1 through the second inverter A2. The signal output by the second inverter A2 is a high-level signal. The PWM control chip U1 outputs the pulse width modulation signal based on the received high-level signal, the isolated switching power supply module U2 outputs the enable signal S3 under the control of the pulse width modulation signal output by the PWM control chip, and the enable signal S3 is a pulse signal. In some embodiments of the present disclosure, the isolated switching power supply module U2 is a flyback power supply or a forward power supply. FIG. 6 shows a schematic diagram of a circuit of a flyback power supply according to an embodiment of the present disclosure. As shown in FIG. 6, the flyback power supply U3 includes a semiconductor switching transistor M3, diodes D11, D12, D13, and D14, and transformers T5 and T6. Since the operating principle of the flyback power supply or the forward power supply is well-known in the art, the details are not described herein again. The schematic diagram of the circuit of the flyback power supply shown in FIG. 6 is exemplary rather than limiting. A flyback power supply or a forward power supply that is well-known to a person skilled in the art may be applied to the present disclosure.

In embodiments of the present disclosure, each uninterruptible power module in the uninterruptible power module UPM 1 to UPM n further includes an auxiliary power supply module, the auxiliary power supply module being configured to: supply power to the module control unit 104 of the uninterruptible power module in which the auxiliary power supply module is located; and serve as a backup power supply of a module control unit 104 of another uninterruptible power module in the uninterruptible power module UPM 1 to UPM n. For example, while supplying power to the module control unit 104 of the UPM 1, the auxiliary power supply module in the UPM 1 may further serve as a backup power supply of the module control unit of the UPM 2.

The present disclosure further provides a control method for the uninterruptible power system according to the embodiments of the present disclosure. The method includes: when the uninterruptible power system needs to be switched to a bypass mode, controlling the system control unit 106 to simultaneously send a first instruction OR1 and a second instruction OR2, where the module controller 1043 sends a first control signal S1 based on the received first instruction OR1, the second controllable switch 105 sends a second control signal S2 based on the received second instruction OR2, the first control signal S1 and the second control signal S2 are in a contention relationship, the signal processing unit 1042 outputs an enable signal S3 based on one of the first control signal S1 or the second control signal S2 that arrives first, and the enable signal S3 controls the uninterruptible power system to switch to the bypass mode.

In the present disclosure, by using the foregoing method, a dual-signal fast start of the UPS in the bypass mode is implemented, which can effectively avoid a case in which bypass mode switching is affected due to a communication packet loss.

In some embodiments of the present disclosure, the foregoing control method for the uninterruptible power system further includes:

when the uninterruptible power system 10 is in the bypass mode and any uninterruptible power module in the uninterruptible power modules UPM 1 to UPM n is faulty, controlling the system control unit 106 to determine, based on a status signal sent by the module control unit 104 that controls the uninterruptible power module, whether the module controller 1043 of the module control unit 104 is faulty;

where when the module controller 1043 is not faulty, the system control unit 106 is controlled to send a first instruction OR1 through the bus port CAN1, the module controller 1043 sends a first control signal S1 based on the received first instruction OR1, the signal processing unit 1042 outputs an enable signal S3 based on the first control signal S1, and the enable signal S3 controls the uninterruptible power system to remain in the bypass mode; and

where when the module controller 1043 is faulty, the system control unit 106 is controlled to send a second instruction OR2 through the first output port P1, the second controllable switch 105 sends a second control signal S2 based on the received second instruction OR2, the signal processing unit 1042 outputs an enable signal S3 based on the second control signal S2, and the enable signal S3 controls the uninterruptible power system to remain in the bypass mode.

In some embodiments of the present disclosure, the module controller 1043 sends a status signal, for example a PWM signal, indicating that it’s in a normal operating state through a bus. The system control unit 106 receives the status signal to determine that the module controller 1043 is in the normal operating state, and determines that the module controller 1043 is faulty when the status signal is not received. This design significantly improves reliability and fault detection efficiency of the system by monitoring the operating state of the module controller 1043 in real time. For example, as a simple and easily identifiable signal form, the PWM signal can quickly transmit operating state information of the module controller 1043. By continuously detecting whether the signal exists or not, the system control unit 106 can timely determine whether the module controller 1043 operates normally. If a loss of signal is detected, the system control unit 106 may immediately start a standby control mechanism, for example, send a second instruction OR2 through the first output port P1, so as to ensure continuous running of the bypass mode and avoid system interruption caused by a fault of the module controller 1043. In addition, such monitoring mechanism based on status signals not only simplifies a fault detection process, but also reduces complexity and costs of the system, and provides a basis for intelligent and automated management of the system.

The present disclosure achieves the maintenance of the bypass mode of the uninterruptible power system by using the foregoing method, in case the module controller of a UPM is faulty, so that a bypass current of each UPM does not increase due to a fault of a UPM and trigger over-temperature protection, thereby improving reliability and availability of the system.

In embodiments of the present disclosure, the alternating current power supply 12 may be a single-phase alternating current power supply or a multi-phase alternating current power supply.

In embodiments of the present disclosure, the first instruction OR1 is a CAN communication signal, and the second instruction OR2 is a level signal. Within an initial time period (for example, 10 milliseconds) in which the uninterruptible power system switches to the bypass mode, the first instruction OR1 and the second instruction OR2 are in a contention relationship. That is, within the initial time period, whichever instruction generates a control signal that arrives at the signal processing unit first will be used to switch the uninterruptible power supply system into the bypass mode. For example, if the first control signal S1 generated based on the first instruction OR1 arrives at the signal processing unit first, the first instruction OR1 will be used to switch the uninterruptible power supply system into the bypass mode. In the present disclosure, the system control unit of the UPS and the module control units of the UPMs of the UPS are optimized, thereby implementing the bypass control of the uninterruptible power system. Compared with the prior art, the present disclosure does not need to use a single-chip microcomputer, thereby reducing costs and simplifying system control. In addition, the present disclosure further implements a dual-signal fast start mechanism of the bypass mode of the UPS, so that a problem of affecting bypass mode switching due to a communication packet loss is effectively avoided, and a defect in the prior art that a single-chip microcomputer or a DSP in the UPM fails to maintain the bypass mode is overcome, thereby significantly improving reliability and availability of the system.

The reference to "various embodiments", "some embodiments", "an embodiment", "embodiments", or the like in the specification means that specific features, structures, or properties described with reference to the embodiments are included in at least one embodiment. Therefore, the phrase "in various embodiments", "in some embodiments", "in an embodiment", "in embodiments", or the like does not necessarily refer to the same embodiment throughout the specification. In addition, the specific features, structures, or properties may be combined in any suitable manner in one or more embodiments. Therefore, the specific features, structures, or properties shown or described with reference to one embodiment may be combined, in whole or in part without limitation, with the features, structures, or properties of one or more other embodiments, provided that the combination is not non-logical or inoperable.

The terms "include" and "have" as well as term expressions with a similar meaning in the specification are intended to cover a non-exclusive inclusion, for example, a process, a method, a system, a product, or a device that includes a series of steps or units is not limited to the listed steps or units, but optionally further includes an unlisted step or unit, or optionally further includes another step or unit inherent to the process, the method, the product, or the device. "An" or "one" does not exclude multiple cases. In addition, the various elements in the accompanying drawings of the present disclosure are merely used for schematic description, and are not drawn in a scale.

Although the present disclosure has been described by using preferred embodiments, the present disclosure is not limited to the embodiments described herein, and includes various changes and variations without departing from the scope of the present disclosure.

1. An uninterruptible power system, comprising:
an input terminal and an output terminal;
at least one uninterruptible power module, each uninterruptible power module of the at least one uninterruptible power module comprising a module controller and a discrete bypass from the input terminal to the output terminal, each respective discrete bypass comprising a first controllable switch configured to control an on and off state of the respective discrete bypass, and each module control unit comprising a module controller and a signal processor;
a second controllable switch; and
a system controller comprising a bus port and a first output port,
wherein the system controller is configured to:
send a first instruction to the module controller of the at least one uninterruptible power module through the bus port, the first instruction being configured to instruct the module controller to send a first control signal, and
send a second instruction to the second controllable switch through the first output port, the second instruction being configured to instruct the second controllable switch to send a second control signal; and
wherein the signal processor is configured to output an enable signal under control of the first control signal or the second control signal, the enable signal being configured to control a closing and opening of the first controllable switch.

2. The uninterruptible power system according to claim 1, wherein the system controller and each module controller each comprise a digital signal processor.

3. The uninterruptible power system according to claim 1, wherein the first controllable switch comprises two silicon controlled rectifiers connected in reverse parallel.

4. The uninterruptible power system according to claim 1, wherein the second controllable switch comprises a plurality of sub-switches that are in a one-to-one correspondence with respective uninterruptible power modules of the at least one uninterruptible power modules,
wherein the plurality of sub-switches each are a transistor,
wherein a base of each transistor is configured to receive the second instruction,
wherein a collector of each transistor is configured to send the second control signal to the signal processor of a respective uninterruptible power module of the at least one uninterruptible power modules corresponding to the respective transistor, and
wherein a transmitter of each transistor is coupled to a ground terminal.

5. The uninterruptible power system according to claim 1, wherein each signal processor comprises a first inverter, a second inverter, a pulse width modulation (PWM) control chip, and an isolated switching power supply module, an input terminal of the first inverter being configured to receive the first control signal, an output terminal of the first inverter being coupled to an input terminal of the second inverter, the input terminal of the second inverter being configured to receive the second control signal, an output terminal of the second inverter being coupled to an input terminal of the PWM control chip, an output terminal of the PWM control chip being coupled to an input terminal of the isolated switching power supply module, and the isolated switching power supply module being controlled by a pulse width modulation signal output by the PWM control chip to output the enable signal.

6. The uninterruptible power system according to claim 5, wherein the isolated switching power supply module is a flyback power supply or a forward power supply.

7. The uninterruptible power system according to claim 1, wherein the module controller is further configured to send a status signal to the system controller through the bus port, and wherein the system is configured to determine, based on the status signal, whether the module controller is faulty.

8. The uninterruptible power system according to claim 1, wherein each uninterruptible power module of the at least one uninterruptible power modules further comprises an auxiliary power supply module being configured to:
supply power to the module control unit of the respective uninterruptible power module in which the auxiliary power supply module is located; and
serve as a backup power supply of the module control unit of another uninterruptible power module of the at least one uninterruptible power modules.

9. A method for controlling the uninterruptible power system according to claim 1, the method comprising:
controlling the system controller to simultaneously send the first instruction and the second instruction, wherein:
the module controller sends the first control signal based on the received first instruction,
the second controllable switch sends the second control signal based on the received second instruction,
the signal processor outputs the enable signal based on one of the first control signal or the second control signal that arrives first, and
the enable signal controls the uninterruptible power system to switch to a bypass mode.

10. The method according to claim 9, further comprising:
when the uninterruptible power system is in the bypass mode and a uninterruptible power module of the at least one uninterruptible power modules is faulty, controlling the system controller to determine, based on a status signal sent by the module control unit that controls the respective uninterruptible power module, whether the module controller of the module control unit is faulty;
wherein when the module controller is not faulty, the system controller is controlled to send the first instruction through the bus port, the module controller sends the first control signal based on the first instruction, the signal processor outputs the enable signal based on the first control signal, and the enable signal controls the respective uninterruptible power system to remain in the bypass mode; and
wherein when the module controller is faulty, the system controller is controlled to send the second instruction through the first output port, the second controllable switch sends the second control signal based on the second instruction, the signal processor outputs the enable signal based on the second control signal, and the enable signal controls the respective uninterruptible power system to remain in the bypass mode.
